(19) United States
(12) Patent Application Publication
(10) Pub. No.: US 2025/0072456 A1
(43) Pub. Date: Mar. 6, 2025

(54) WET PET FOOD PALATABILITY ENHANCER, AND WET PET FOOD

(71) Applicant: Unicharm Corporation, Ehime (JP)

(72) Inventors: Hitomi Nakashima, Itami-shi (JP); Kotaro Yoshida, Itami-shi (JP)

(73) Assignee: Unicharm Corporation, Ehime (JP)

(21) Appl. No.: 18/949,794

(22) Filed: Nov. 15, 2024

Related U.S. Application Data
(63) Continuation of application No. PCT/JP2023/018440, filed on May 17, 2023.

(30) Foreign Application Priority Data
May 18, 2022 (JP) 2022-081251

(51) Int. Cl. A23K 50/48; A23K 10/16; A23K 10/20; A23K 20/147; A23K 20/163

(52) U.S. Cl. CPC A23K 50/48; A23K 10/16; A23K 10/20; A23K 20/147; A23K 20/163

(57) ABSTRACT

A wet pet food palatability enhancer includes: a palatability agent component selected from a group consisting of a protein hydrolysate and a yeast extract; a free glycine; and a reducing sugar. A phosphorus content of the wet pet food palatability enhancer is 1% or less in terms of dry matter. The wet pet food palatability enhancer does not include a Maillard reaction product.

### CROSS-REFERENCE TO RELATED APPLICATIONS

The present application is a bypass application of PCT Application No. PCT/JP2023/018440, filed on May 17, 2023, which claims priority to Japanese Patent Application No. 2022-081251, filed on May 18, 2022. The contents of these documents are incorporated by reference in their entirety.

### TECHNICAL FIELD

The present invention relates to a wet pet food palatability enhancer and a wet pet food.

### BACKGROUND

Conventionally, palatability enhancers have been added to pet foods in order to enhance palatability. Many palatability enhancers contain phosphate from the viewpoint of palatability and storage performance (for example, refer to Patent Literature 1).

On the other hand, as a palatability enhancer that does not contain phosphate, for example, Patent Literature 2 proposes a palatability enhancer containing a Maillard reaction product produced by adding reducing sugar to a peptide-containing substance in a predetermined amount with respect to the peptide-containing substance, and heating the mixture, and a remaining peptide.

### CITATION LIST

### Patent Literature

Patent Literature 1: Published Japanese Translation No. 2009-534020 of the PCT International Publication

Patent Literature 2: Japanese Unexamined Patent Publication No. 2017-086079

However, phosphate may cause a decrease in kidney function and kidney disease with a high phosphorus diet. Specifically, according to research, as a no observed adverse effect level (NOAEL), the amount of phosphorus derived from sodium tripolyphosphate (STPP) is considered to be up to 1.0 g per 1000 kcal, which is an amount that does not cause a change in GFR as a primary index of kidney function. Therefore, in order to reduce the burden on the kidneys of pets, there is a demand for a palatability enhancer having a low phosphate content.

On the other hand, the palatability enhancer described in Patent Literature 2 includes a Maillard reaction product. Therefore, when the palatability enhancer is added to a wet food, there is a risk that the Maillard reaction occurs again during a retort step of the wet food, and the color of the final product becomes dark. Further, due to the Maillard reaction occurred again, caramelization or the like is likely to occur, and there is a risk that the final product may have a bitter taste.

### SUMMARY

One or more embodiments of the present invention provide a wet pet food palatability enhancer, which has a good palatability with reduced phosphorus content, easily adjusts the color of a wet pet food, and is less likely to produce a bitter taste, and a wet pet food to which the wet pet food palatability enhancer is applied.

One or more embodiments of the present invention have the following aspects.
(1) A wet pet food palatability enhancer comprising: at least one palatability agent component selected from the group consisting of a protein hydrolysate and a yeast extract; a free glycine; and a reducing sugar, wherein a phosphorus content is 1% or less in terms of dry matter, and a Maillard reaction product is not contained.
(2) The wet pet food palatability enhancer according to (1), wherein a content of the free glycine is equal to or higher than a content of the reducing sugar.
(3) The wet pet food palatability enhancer according to (1) or (2), wherein a ratio of the free glycine to the reducing sugar is 1:1 to 4:1.
(4) The wet pet food palatability enhancer according to any one of (1) to (3), wherein a content of the free glycine is 0.8% to 30%.
(5) The wet pet food palatability enhancer according to any one of (1) to (4), wherein a content of the reducing sugar is 0.2% to 30%.
(6) The wet pet food palatability enhancer according to any one of (1) to (5), wherein the at least one palatability agent component contains 12% or more of protein in terms of dry matter.
(7) The wet pet food palatability enhancer according to any one of (1) to (6), wherein the at least one palatability agent component is a protein hydrolysate using a chicken-derived raw material and/or a decomposition product using a yeast-derived raw material.
(8) The wet pet food palatability enhancer according to any one of (1) to (7), wherein a content of the reducing sugar after a Maillard reaction is 0.05% or less with respect to a total amount of a pet food. (9) A wet pet food containing a Maillard reaction product of the wet pet food palatability enhancer according to any one of (1) to (8).

According to the wet pet food palatability enhancer of one or more embodiments, even when the phosphate content is low, reaction products of both a Maillard reaction caused by glycine and the reducing sugar and a Maillard reaction caused by the protein decomposition product and the reducing sugar are produced, and palatability is enhanced. Further, since the Maillard reaction product is not contained (that is, the palatability enhancer is one before the Maillard reaction), when the palatability enhancer is added to a wet pet food and subjected to a retort step, the color is not darkened and a bitter taste is not caused by caramelization or the like.

### DETAILED DESCRIPTION

In the present description, the term “pet” refers to an animal raised by a person. In a narrower sense, a pet is an animal that is cherished by its owner. Further, the term “pet food” means feed for pets.

In the present description, the “palatability” is an index of whether a pet favors to eat, and is caused by texture, taste, odor, and the like.

In the present description, a percentage of the moisture content (weight %) of a pet food is determined by a normal pressure heating and drying method. The percentage of the moisture content determined by this method also includes the moisture in the ingredients.

### Normal Pressure Heating and Drying Method

The weight of an aluminum weighing can (W1 grams) is measured in advance as a constant weight value. A sample is introduced into this aluminum weighing can, and the weight (W2 grams) is weighed. Next, the sample is dried under the conditions of 135° C. for 2 hours by using a forced circulation type warm air dryer. After the sample is left to cool in a dry atmosphere (in a silica gel desiccator), the weight (W3 grams) is weighed. From the respective obtained weights, the percentage of the moisture content is determined by using the following formula.

$$Percentage of Moisture Content ( unit : weight \% ) = ( W 2 - W 3 ) \div ( W 2 - W 1 ) \times 100$$

### <Wet Pet Food Palatability Enhancer>

A wet pet food palatability enhancer according to one or more embodiments contains at least one palatability agent component selected from the group consisting of a protein hydrolysate and a yeast extract, a free glycine, and a reducing sugar.

Since at least one palatability agent component selected from the group consisting of a protein hydrolysate and a yeast extract, a free glycine, and a reducing sugar are contained in the wet pet food palatability enhancer, even when the phosphate content is low, reaction products of both a Maillard reaction caused by glycine and the reducing sugar and a Maillard reaction caused by the protein decomposition product and the reducing sugar are produced, and palatability is enhanced.

In the wet pet food palatability enhancer according to one or more embodiments, a phosphorus content is 1% or less with respect to a total amount of the wet pet food palatability enhancer in terms of dry matter.

When the phosphorus content is 1% or less, it is expected that the burden on the kidneys of pets is reduced.

The phosphorus content in the wet pet food palatability enhancer is may be 1% or less, may be 0.5% or less, or may be 0.05% or less, with respect to the total amount of the wet pet food palatability enhancer in terms of dry matter.

When the phosphorus content is within the above-mentioned range, it is expected that the burden on the kidneys of pets is further reduced.

The wet pet food palatability enhancer according to one or more embodiments does not contain a Maillard reaction product. That is, the wet pet food palatability enhancer according to one or more embodiments is not subjected to a Maillard reaction.

Since the Maillard reaction product is not contained, when the wet pet food palatability enhancer is added to a wet pet food and subjected to a retort step, the color is easily adjusted and a bitter taste can be prevented from being caused by caramelization or the like.

Hereinafter, each component of the wet pet food palatability enhancer will be described.

### Palatability Agent Component

In one or more embodiments, the palatability component is not particularly limited as long as at least one selected from the group consisting of a protein hydrolysate and a yeast extract is contained. The protein hydrolysate is an animal or vegetable raw material, and the decomposition method includes enzymatic decomposition or acid decomposition, autodigestion, and the like.

Examples of the animal raw material include decomposed products derived from chickens, pigs, cows, and sheep, dairy products, and seafood. Examples of the vegetable raw material include raw materials derived from plants other than those mentioned above, such as beans, potatoes, cereals, fruits, seeds, vegetables, and seaweed.

Examples of the yeast extract include decomposed products using raw materials derived from yeast such as beer yeast, bakery yeast, and torula yeast, and examples of the decomposition method include enzymatic decomposition, acid decomposition, and autodigestion.

In one or more embodiments, from the viewpoint of further enhancing palatability, the at least one palatability agent component may be a protein hydrolysate using a chicken-derived raw material and/or a decomposition product using a yeast-derived raw material.

In one or more embodiments, the at least one palatability agent component contains 12% or more of protein, may contain 25% or more of protein, or may contain 40% or more of protein in terms of dry matter.

When the content of the protein in the at least one palatability agent component is within the above-mentioned range, the Maillard reaction easily occurs when the wet pet food palatability enhancer is added to a wet food and subjected to a retort step, and thus palatability is easily enhanced.

In one or more embodiments, the content of the at least one palatability agent component is not particularly limited, and may be 30% to 90%, may be 40% to 80%, or may be 50% to 70%, with respect to the total amount of the wet pet food palatability enhancer.

In one or more embodiments, the amount of the wet pet food palatability enhancer added to the wet pet food is not particularly limited, and may be 0.1% to 6%, may be 0.2% to 5%, or may be 0.5% to 4%, with respect to the total amount of the pet food.

### Free Glycine

In one or more embodiments, the free glycine means a free glycine that is not derived from the at least one palatability agent component but is blended as a component different from the at least one palatability agent component.

In one or more embodiments, the content of the free glycine may be 0.8% to 30%, may be 10% to 30%, or may be 20% to 30%, with respect to the total amount of the wet pet food palatability enhancer. When the content of the free glycine is within the above-mentioned range, a reaction product of glycine and sugar is easily and more reliably produced by the Maillard reaction when the wet pet food palatability enhancer is added to a wet food and subjected to a retort step. Accordingly, palatability is easily enhanced.

### Reducing Sugar

In one or more embodiments, the reducing sugar is not particularly limited. Examples thereof include xylose, glucose, fructose, lactose, maltose, and the like, and one or plural kinds thereof may be mixed. Among these, the reducing sugar may be maltose, xylose or glucose.

In one or more embodiments, the content of the reducing sugar may be 0.2% to 30%, may be 10% to 30%, or may be 10% to 20%, with respect to the total amount of the wet pet food palatability enhancer. When the content of the reducing sugar is within the above-mentioned range, the Maillard reaction easily occurs when the wet pet food palatability enhancer is added to the wet food and subjected to the retort step, and palatability is easily enhanced.

In one or more embodiments, the free glycine content is equal to or higher than the content of the reducing sugar.

When the free glycine content is equal to or higher than the content of the reducing sugar, after the wet pet food palatability enhancer is added to the wet food and subjected to the retort step to cause a Maillard reaction, the free glycine easily remains in the wet food. Therefore, since both the Maillard reaction product and the free glycine that remains unreacted are present in the wet food, palatability is easily enhanced.

In one or more embodiments, a ratio of the free glycine to the reducing sugar may be 1:1 to 4:1, may be 1:1 to 3:1, or may be 1:1 to 2:1.

When the ratio of the free glycine to the reducing sugar is within the above-mentioned range, the Maillard reaction occurs efficiently when the wet pet food palatability enhancer is added to the wet food and subjected to the retort step. Therefore, palatability is easily enhanced.

In a wet pet food palatability enhancer according to one or more embodiments, a content of the reducing sugar in the wet food is 0.05% or less (detection limit amount or less) after the wet pet food palatability enhancer is added to a wet food and subjected to a retort step to cause a Maillard reaction. When the content of the reducing sugar in the wet food after the Maillard reaction is 0.05% or less (detection limit amount or less), the health of a pet (particularly, a cat) is easily secured while palatability is enhanced.

A wet pet food palatability enhancer according to one or more embodiments has a Na content of 1% or less.

When the Na content is within the above-described range, the Na nutritional content of the entire wet food is easily adjusted while palatability is enhanced. Further, other sodium salts can be used in the wet food.

### <Wet Pet Food>

A wet pet food according to one or more embodiments contains a Maillard reaction product of the wet pet food palatability enhancer. That is, the wet pet food according to one or more embodiments is obtained by adding the wet pet food palatability enhancer to a wet food and subjecting the wet food to a retort step to cause a Maillard reaction.

It should be noted that the wet pet food according to one or more embodiments may be obtained by independently adding at least one palatability agent component selected from the group consisting of a protein hydrolysate and a yeast extract, a free glycine, and a reducing sugar to a wet food, and subjecting the wet food to a retort step to cause a Maillard reaction.

The wet pet food according to one or more embodiments is not particularly limited as long as the wet pet food contains a Maillard reaction product of the wet pet food palatability enhancer, and a known wet food can be applied.

### Wet Food

In one or more embodiments, the wet food refers to a pet food including a large amount of moisture as compared with a dry food that has been subjected to a drying treatment, as a final form offered to the market. The percentage of the moisture content of the pet food may be 50 mass % or more, may be 60 mass % or more, may be 65 mass % or more, or may be 70 mass % or more, with respect to the total mass of the pet food.

The wet food typically includes a base portion and may further include a chunk portion and/or flakes. Here, the term “chunk” refers to a portion obtained by solidifying raw materials into small pieces, and the chunk portion refers to a set of chunks. The term “flakes” refers to finely divided fish and meat pieces. The “base” portion refers to a wet portion of the pet food other than the chunk portion and the flake portion.

The proportion of the chunk portion and/or flakes included in the wet food is not particularly limited, and the proportion may be 0 to 50 mass %, or may be 0 to 40 mass %, with respect to the total mass of the pet food.

In one or more embodiments of the present invention, the wet food palatability enhancer is included in the base portion or the chunk portion.

The shape of the chunk is not particularly limited, and examples thereof include shapes formed into pellets (grains), such as a spherical shape, a polygonal shape, a columnar shape, a donut shape, a plate shape, or a Go-stone shape. The size of such a pellet is not particularly limited; however, for example, when a pellet placed on a horizontal table is viewed from above, the minor axis and the major axis may be 1 to 25 mm and the thickness from the lower surface (lower end) to the upper surface (upper end) of the pellet on the horizontal table may be 1 to 20 mm; the minor axis and the major axis may be 3 to 11 mm and the thickness may be 3 to 9 mm; or the minor axis and the major axis may be 5 to 9 mm and the thickness may be 5 to 8 mm.

The mode of the base portion is not particularly limited, and examples thereof include modes such as a liquid form, a gel form, a solid form, and the like, or combinations thereof. Furthermore, when the base portion contains a solid, the shape is not particularly limited, and examples thereof include shapes similar to the above-described shapes of chunks.

A pet food product according to one or more embodiments is particularly for cats and dogs.

### <Raw Materials>

The raw materials that constitute the wet food is not particularly limited except for the above-mentioned wet food palatability enhancer, and the raw materials used in the conventional pet foods can be applied. For example, in addition to protein components, carbohydrate components, vitamins, minerals, salts, fats, oils, and the like may be added.

When preparing a wet food, a thickener may be added as a raw material.

Examples of the thickener include polysaccharides such as guar gum, starch, carrageenan, xanthan gum, and locust bean gum.

When fish such as tuna, sardine, and bonito, or domestic animals such as beef, pork, and chicken are used as the protein components included in the raw materials of the wet food, these raw materials may be heated or cooked in advance by known methods.

The wet food can be produced by, for example, mixing protein components and water, and adding a thickener as necessary. The mixing method is not particularly limited, any known method of using a mixer or a mincer can be applied, and a method capable of performing uniform mixing may be employed. Each of the raw materials can be mixed more uniformly by mixing (processing) the protein components in advance into a minced-meat-like form and then mixing the protein components with other raw materials. After the mixing, the pet food may be in a paste form. Furthermore, clumpy (solid) ingredients may be dispersed in the paste-like pet food. By mixing the raw materials in the pet food uniformly or making the pet food in the form of a paste, the pet can be suppressed from eating only a portion of the pet food or only some of the raw materials, and the rate of complete eating can be enhanced.

The time and temperature for mixing the raw materials can be appropriately set. By adjusting the mixing time, the viscosity of the pet food can be adjusted. Furthermore, the viscosity and the moisture content of the pet food can be adjusted by adjusting the amount of water to be mixed. The viscosity of pet food can also be adjusted by the blending amount of the thickener.

Usually, wet food is not in the form in which solid ingredients and a liquid soup are separated from each other, but has a form in which only the paste-like component having the above-mentioned specific viscosity and moisture content is contained, or the paste-like component and solid ingredients are entangled. In one or more embodiments, the wet food is not in the form in which the soup component and the solid ingredients are separated, but at least partially has a paste-like form (component) having the above-mentioned viscosity and moisture content. In addition to the paste-like component, the pet food may contain a solid ingredient. In this case, since the solid ingredient is in a form of being entangled with the paste-like component, the solid ingredient is carried into the pet's mouth together with the paste-like component. The rate of complete eating of the wet food can be enhanced.

When the wet food includes a chunk portion, the chunk portion and the base portion can be produced by using the raw materials as shown below.

### Base Portion Raw Material

The raw materials included in the base portion of the wet food are not particularly limited; however, a protein raw material can be used as the main raw material in the base portion. Examples of the protein raw material of the base portion include plant-derived proteins, animal-derived proteins, and mixtures thereof. Specifically, examples of the plant-derived proteins include gluten, wheat protein, soybean protein, rice protein, and corn protein. Examples of the animal-derived proteins include proteins such as muscles and organs of cattle, pig, chicken, and fish and shellfish; proteins of milk; or mixtures thereof.

As raw materials of the base portion other than those mentioned above, fats and oils, the wet food palatability enhancer, a thickener, water, and the like can be added.

### Chunk Portion Raw Material

A protein raw material can be used for the chunk portion of the pet food. Regarding the protein raw material for the chunk portion, protein raw materials similar to those used for the base portion can be used.

Furthermore, cereals may be added to the chunk portion of the pet food. Regarding the cereals, corn, wheat, barley, oats, rice, and soybean can be mentioned as examples. Since these cereals may include proteins, ash, minerals, vitamins, and the like in addition to carbohydrates, the cereals can be used as a nutrient source. Furthermore, by adding cereals, it is easy to adjust (mainly reduce) the blending ratio of amino acids with respect to the entire pet food.

As raw materials of the chunk portion other than those mentioned above, the wet food palatability enhancer, a binder, water, and the like can be added.

### Retort Step

The retort step is not particularly limited, and conventionally known methods can be applied. Specifically, a wet pet food palatability enhancer or at least one palatability agent component selected from the group consisting of a protein hydrolysate and a yeast extract, a free glycine, and a reducing sugar are added to a wet food, and the wet food is placed in a pouch container. Then, retort sterilization is performed by well-known heat treatment or pressure treatment. The retort sterilization step is not particularly limited as long as a condition that allows sufficient sterilization of the pet food is provided, and the retort sterilization step may be performed under the condition in which the flavor of the pet food is not deteriorated after the sterilization treatment. For the retort sterilization, heat treatment may be performed at a temperature of, for example, 110° C. to 130° C. for about 5 minutes to 50 minutes. The container is not limited to a pouch container, and a well-known wet food container can be appropriately used. For example, a can or a cup container may be used.

### EXAMPLES

Hereinafter, embodiments the present invention will be described in more detail with reference to Examples, but is not limited to these Examples.

### Examples 1 to 6 and Comparative Example 1

In the formulations shown in Table 1, raw materials constituting the wet pet food palatability enhancer were mixed to obtain a wet pet food palatability enhancer of each example. The wet pet food palatability enhancer of each example was added to a wet food prepared by mixing fish meat, a thickener, and water, and retorted at 121° C. to obtain a wet pet food product.

In Table 1, the blending amount (%) of each raw material of the palatability enhancer is a percentage with respect to the total amount of the palatability enhancer.

In addition, in Table 1, the phosphorus content (%) in the palatability enhancer is a percentage with respect to the total amount of the palatability enhancer.

In addition, in Table 1, the palatability enhancer content ratio (%) in the product is a percentage with respect to the total amount of the wet food and the palatability enhancer.

TABLE 1

| | | | Comparative | Example | Example | Example | Example | Example | Example |
|---|---|---|---|---|---|---|---|---|---|
| | | | Example 1 | 1 | 2 | 3 | 4 | 5 | 6 |
| Formulation | Palatability enhancer | | 2.00% | 1.25% | 1.25% | 1.10% | 1.55% | 2.15% | 1.45% |
| | content ratio in product | | | | | | | | |
| | Phosphorus content in | | 4.80% | 0.61% | 0.00% | 0.69% | 0.49% | 0.16% | 0.40% |
| | palatability enhancer | | | | | | | | |
| | Palatability | Palatability agent | 100% | | | | | | |
| | enhancer | containing phosphate | | | | | | | |
| | | Protein hydrolysate (Chicken- | | 64.00% | | 72.73% | 51.61% | | 34.48% |
| | | based palatability agent) | | | | | | | |
| | | Amino acid (Glycine) | | 24.00% | 24.00% | 13.64% | 38.71% | 13.95% | 20.69% |
| | | Reducing sugar (Xylose) | | 12.00% | 12.00% | 13.64% | 9.68% | 6.98% | 10.34% |
| | | Yeast extract (Yeast-based | | | | | | 79.07% | 34.48% |
| | | palatability agent) | | | | | | | |
| | | Protein hydrolysate (Plant- | | | 64.00% | | | | |
| | | based palatability agent) | | | | | | | |

| | | | | | | |
|---|---|---|---|---|---|---|
| Palatability Evaluation Result | 59 | 52 | 55 | 47 | 56 | 60 |

### Palatability Evaluation Test

### <Evaluation of Palatability>

The palatability of each pet food P of Examples 1 to 6 and that of pet food Q of Comparative Example 1 were evaluated by a method of comparing the food intake. Twenty cats were monitored and tested for 2 days. On the first day, pet foods P and Q were fed simultaneously, one from the left side and the other from the right side, at a predetermined feed amount to one cat, and the amount of the pet food eaten by the cat was measured at the time from when the cat completely consumed either one of the pet foods P and Q or 30 minutes after the feeding.

The ratio (P:Q, P+Q=100%) of the intake of pet food Q and the intake of pet food P with respect to the total mass of the pet food eaten by the cat on the first day, was calculated as a percentage. The percentages obtained, based on the number of cats monitored, were averaged as the results of the first day.

On the second day, the pet foods P and Q were fed simultaneously, one from the right side and the other from the left side, contrary to the first day. One cat was fed the same amount as on the first day, and the amount of pet food eaten by the cat was measured at the time from when the cat completely consumes either one of the pet foods or 1 hour after the feeding. The results of the second day were obtained by the similar calculation method as that of the first day.

Finally, the results of the first day and the second day were averaged to calculate the ratio “P:Q” of the food intake of pet food P:pet food Q, which is the final result. The results are shown in Table 1.

The palatability was evaluated according to the following criteria.

P is 45 to 55: The palatability of pet food P is equal to the palatability of pet food Q.

P is 56 or more: The palatability of pet food P is higher than the palatability of pet food Q.

From the results shown in Table 1, it was confirmed that although the wet pet foods of Examples 1 to 6 did not contain the phosphate palatability enhancer, the palatability equal to or higher than that of the wet pet food of Comparative Example 1 containing the phosphate palatability enhancer could be obtained. Further, from the results shown in Table 1, it was confirmed that the palatability was particularly enhanced in a case where a protein hydrolysate using a chicken-derived raw material and/or a decomposed product using a yeast-derived raw material as a palatability agent component was used.

### INDUSTRIAL APPLICABILITY

For a wet food palatability enhancer according to one or more embodiments of the present invention, the palatability when the wet food palatability enhancer is added to a wet food is enhanced, the color of the wet food is easily adjusted, and the wet food is less likely to have a bitter taste.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A wet pet food palatability enhancer comprising:
a palatability agent component selected from a group consisting of a protein hydrolysate and a yeast extract;
a free glycine; and
a reducing sugar, wherein
a phosphorus content of the wet pet food palatability enhancer is 1% or less in terms of dry matter, and
the wet pet food palatability enhancer does not include a Maillard reaction product.

2. The wet pet food palatability enhancer according to claim 1, wherein
a content of the free glycine is equal to or greater than a content of the reducing sugar.

3. The wet pet food palatability enhancer according to claim 1, wherein
a ratio of the free glycine to the reducing sugar is greater than or equal to 1:1 and less than or equal to 4:1.

4. The wet pet food palatability enhancer according to claim 1, wherein
a content of the free glycine is 0.8% to 30% with respect to the total amount of the wet pet food palatability enhancer.

5. The wet pet food palatability enhancer according to claim 1, wherein
a content of the reducing sugar contained is 0.2% to 30% with respect to the total amount of the wet pet food palatability enhancer.

6. The wet pet food palatability enhancer according to claim 1, wherein
the palatability agent component contains 12% or more of protein in terms of dry matter.

7. The wet pet food palatability enhancer according to claim 1, wherein
the palatability agent component is:
a protein hydrolysate using a chicken-derived raw material; or
a decomposition product using a yeast-derived raw material.

8. The wet pet food palatability enhancer according to claim 1, wherein
a content of the reducing sugar after a Maillard reaction is 0.05% or less with respect to a total amount of a pet food.

9. A wet pet food containing a Maillard reaction product resulting from the wet pet food palatability enhancer according to claim 1.

10. The wet pet food palatability enhancer according to claim 1, wherein
the palatability agent component includes:
a protein hydrolysate using a chicken-derived raw material; and
a decomposition product using a yeast-derived raw material.
